(19) United States
(12) Patent Application Publication
(10) Pub. No.: US 2012/0020639 A1
(43) Pub. Date: Jan. 26, 2012

(54) IMAGE PROCESSING APPARATUS AND IMAGE PICKUP APPARATUS USING THE IMAGE PROCESSING APPRATUS

(75) Inventors: Hideo HIRONO, Moriguchi City (JP); Shigeyuki OKADA, Moriguchi City (JP)

(73) Assignee: SANYO Electric Co., Ltd., Moriguchi City (JP)

(21) Appl. No.: 13/185,891

(22) Filed: Jul. 19, 2011

(30) Foreign Application Priority Data
Jul. 20, 2010 (JP) 2010-162486
Jul. 29, 2010 (JP) 2010-171032

(51) Int. Cl. H04N 5/77; H04N 5/93; H04N 7/18

(52) U.S. Cl. 386/227; 348/77; 386/278; 386/E05.069; 386/E05.028; 348/E07.085

(57) ABSTRACT

A first acquisition unit acquires images from a first image pickup unit for picking up moving images for use in recording. A second acquisition unit acquires images from a second image pickup unit for picking up the image of a person taking the moving images. A decision unit determines whether or not the person taking the moving images is viewing a monitor for displaying the moving images for use in recording, based on the images acquired from the second acquisition unit. A control unit varies the status of an image pickup apparatus according to the decision results of the decision unit.

This application is based upon and claims the benefit of priority from the prior Japanese Patent Applications No. 2010-162486, filed on Jul. 20, 2010, and Japanese Patent Application No 2010-171032, filed on Jul. 29, 2010, the entire contents of which are incorporated herein by reference.

### BACKGROUND OF THE INVENTION

1. Field of the Invention

The present invention relates to an image processing apparatus for coding, playing back, editing or storing moving images to be picked up, and an image pickup apparatus carrying said image processing apparatus.

2. Description of the Related Art

Digital movie cameras with which average users can readily take moving pictures have been widely in use. Among such digital movie cameras, there are those featuring full high-definition (HD) image quality (1920×1080 pixels). The moving images captured by such a digital movie camera are used for various kinds of purposes. For example, those moving images are viewed on televisions and PC screens, and are also transmitted through the attachment to electronic mails and are uploaded to video-sharing sites, blah sites or SNS (Social Networking Service) sites. Although the digital movie cameras in recent years incorporate an increasing range of functions, those many sophisticated functions are usually not fully utilized by the users

In particular, it is extremely difficult for the users who are not familiar with how to handle the digital movie cameras properly and for those who are not comfortable with electronic devices in general including highly computerized cameras to fully utilize the functions provided in the digital movie cameras. For example, a camera-shake correction function (hereinafter referred to simply as “shake correction function” also) is switched off and thus this function is left unused while the camera takes the moving images. For example, in contrast, this shake correction function is used at its full power at all times and thus the power is consumed more than necessary, thus wasting the power without really knowing accordingly.

### SUMMARY OF THE INVENTION

An image processing apparatus according to one embodiment of the present invention is an image processing apparatus which is to be mounted on an image pickup apparatus that picks up moving images, and the image processing apparatus includes: a first acquisition unit configured to acquire an image from a first image pickup unit that picks up a moving image for use in recording; a second acquisition unit configured to acquire an image from a second image pickup unit that picks up an image of a person taking the moving images; a decision unit configured to determine whether or not the person taking the moving image is viewing a monitor that displays the moving image for use in recording, based on the image acquired from the second acquisition unit; and a control unit configured to vary a status of the image pickup apparatus according to a decision result of the decision unit.

Another embodiment of the present invention relates to an image pickup apparatus. This apparatus includes: a first image pickup unit configured to pick up a moving image for use in recording; a second image pickup unit configured to pick up an image of a person taking the moving image; and the above-described image processing apparatus.

An image processing apparatus according to still another embodiment of the present invention includes: a first acquisition unit configured to acquire an image from a first image pickup unit that picks up a moving image for use in recording; an image coding unit configured to code the image acquired by said first acquisition unit so as to generate coded data of moving images, a second acquisition unit configured to acquire an image from a second image pickup unit that picks up an image of a person taking the moving image; a decision unit configured to determine whether or not the person taking the moving image is viewing a monitor that displays the moving image for use in recording, based on the image acquired from the second acquisition unit; and an appending unit configured to relate information on a line-of-sight of the person taking the moving image to the coded data of moving image wherein the line-of-sight information specifies whether the person taking the moving image is viewing the monitor or not.

Still another embodiment of the present invention relates to an image pickup apparatus. This apparatus includes: a first image pickup unit configured to pick up a moving image for use in recording; a second image pickup unit configured to pick up an image of a person taking the moving image; and the above-described image processing apparatus.

Still another embodiment of the present invention relates to an image processing apparatus. This apparatuses is an image processing apparatus that reproduces the coded data of moving image generated by an image processing apparatus, the coded data of moving image being related to the information on a line-of-sight of a person taking the moving image, and the image processing apparatus includes: a decoding unit configured to decode the coded data of moving image; and a control unit configured to perform control such that the moving image decoded by the decoding unit is reproduced either by accessing a position, identified by the line-of-sight information, where the person taking the moving image starts to view the monitor or by joining together periods, identified by the line-of-sight information, during which the person taking the moving image is viewing the monitor.

Still another embodiment of the present invention relates also to an image processing apparatus. This apparatuses is an image processing apparatus for editing the coded data of moving image generated by an image processing apparatus, the coded data of moving image being related to the information on a line-of-sight of a person taking the moving image, and the image processing apparatus includes: a decoding unit configured to decode the coded data of moving image; and a control unit configured to perform control such that a part of the moving images corresponding to a period, identified by the line-of-sight information, during which the person taking the moving image is not viewing the monitor is deleted, or the entire moving images is deleted when the moving images decoded by the decoding unit contain the period, identified by the line-of-sight information, during which the person taking the moving image is not viewing the monitor.

Still another embodiment of the present invention relates also to an image processing apparatus. This apparatuses is an image processing apparatus that stores the coded data of moving image generated by an image processing apparatus, the coded data of moving image being related to the information on a line-of-sight of a person taking the moving image, and the image processing apparatus includes: a ratio calculating unit configured to calculate a ratio of a viewing period over a non-viewing period for each of a plurality of coded data of moving images wherein the viewing period is a period, identified by the line-of-sight information, during which the person taking the moving image is viewing the monitor and the non-viewing period is a period, identified by the line-of-sight information, during which the person taking the moving image is not viewing the monitor; and a sorting unit configured to sort out the plurality of coded data of moving images in the order starting from coded data whose calculated ratio is maximum or minimum.

Still another embodiment of the present invention relates to an image pickup apparatus. This apparatus includes at least one above-described image processing apparatus.

Optional combinations of the aforementioned constituting elements, and implementations of the invention in the form of methods, apparatuses, systems, recording media, computer programs and the like may also be practiced as additional modes of the present invention.

### BRIEF DESCRIPTION OF THE DRAWINGS

Embodiments will now be described by way of examples only, with reference to the accompanying drawings which are meant to be exemplary, not limiting, and wherein like elements are numbered alike in several Figures in which:

FIG. 1 is a schematic external view of an image pickup apparatus according to first and second embodiments according to the present invention;

FIG. 2 shows a structure of an image pickup apparatus provided with an image processing apparatus according to a first embodiment of the present invention;

FIG. 3 illustrates relations among a frame image inputted to a branching unit, a frame image coded by a first image coding unit, and a frame image coded by a second image coding unit;

FIG. 4 illustrates an exemplary switching timing between a single codec mode, in which the moving images are coded at the HD image quality, and a dual encode mode, in which the moving images are coded at the HD image quality and the SD image quality;

FIG. 5 illustrates an exemplary switching timing between a single codec mode, in which the moving images are coded at the SD image quality, and a dual encode mode, in which the moving images are coded at the HD image quality and the SD image quality;

FIGS. 6A to 6C illustrate an example where a shake correction unit performs a shake correction;

FIGS. 7A to 7C illustrate an example where an auto framing processing unit performs an auto-framing process;

FIG. 8 shows a structure of an image pickup apparatus provided with an image processing apparatus according to a second embodiment of the present invention;

FIG. 9 shows a structure of an image display system provided with an image processing apparatus according to a third embodiment of the present invention;

FIG. 10 is a diagram to explain an access (cue) playback control performed by a control unit according to a third embodiment;

FIG. 11 is a diagram to explain a digest playback control performed by a control unit according to a third embodiment;

FIG. 12 is a diagram to explain an automatic editing control performed by a control unit according to a third embodiment;

FIG. 13 shows a structure of a control unit according to a third exemplary operation;

FIGS. 14A and 14B are diagrams to explain a file sorting performed by a control unit according to a third embodiment; and

FIGS. 15A to 15C are diagrams showing an example of auto-framing playback processing performed by a control unit according to a third embodiment.

### DETAILED DESCRIPTION OF THE INVENTION

The invention will now be described by reference to the preferred embodiments. This does not intend to limit the scope of the present invention, but to exemplify the invention.

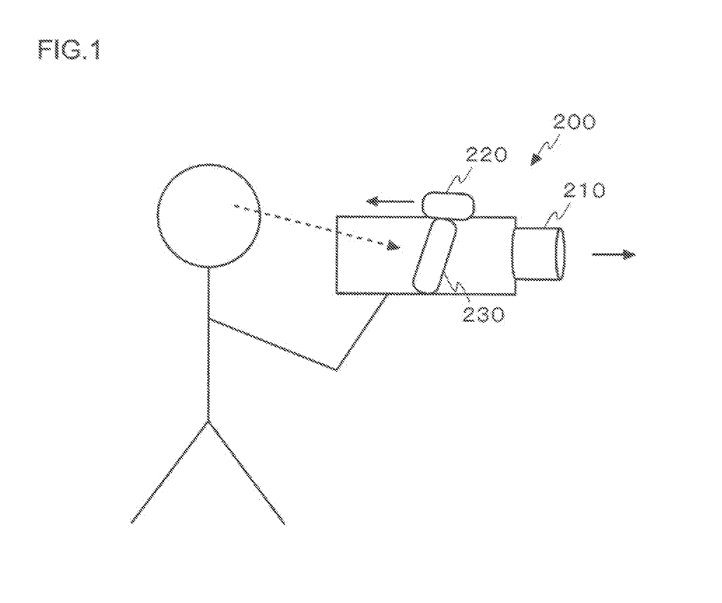

FIG. 1 is a schematic external view of an image pickup apparatus 200 according to first and second embodiments according to the present invention. A first image pickup unit 210, a second image pickup unit 200 and a monitor 230 are installed in the image pickup apparatus 200. The first image pickup unit 210 is a main camera used to take the moving images of an object or objects such as a person (persons), landscape, or structural objects (railroad vehicle, etc.). The second image pickup unit 220 is a sub-camera used to take the images of a person taking the moving images thereof, more specifically, eyes of the person taking the moving images thereof. A monitor (hereinafter referred to as “viewfinder” or “finder” also) 230 displays mainly the moving images captured by the first image pickup unit 210.

The second image pickup unit 220 is not a so-called camera for capturing an image of the face, for instance, of the person taking the moving images and recording it but a camera used to determine whether the person taking the moving images (hereinafter referred to as “photographer” also) is viewing the monitor 230. Thus, the images captured by the second image pickup unit 220 is basically not recorded and therefore discarded. In contrast thereto, the first image pickup unit 210 is a camera used to captures the moving images for use in recording.

The second image pickup unit 220 is installed at a position where the images by which whether or not the photographer is viewing the monitor 230 is determined can be captured. More specifically, such a position is preferably a spot where the photographer of the image pickup unit 200 can usually hold the camera steadily and where the face of the photographer can be captured. For example, the second image pickup unit 220 may be installed at any position along a peripheral side or edge of the monitor 230.

Determining whether or not the photographer is viewing the monitor 230 allows one to estimate or speculate the action and the psychological state of the photographer as follows.

Firstly, if the photographer is watching the monitor 230, the following speculations may be made.

1. The photographer thinks that he/she does not want to miss out on the scenes being presently captured (namely, he/she does not want to make any mistake while capturing the images).
2. The photographer is in the midst of changing an targeted object to be captured or a composition.
3. The photographer is in the midst of changing the zoom magnification.
4. The photographer is concentrating on taking the moving images of a target more seriously than normal because a subtle movement of the camera causes the target to be out of frame.

Then, if the photographer is not watching the monitor 230, the following speculations may be made.

1. The photographer does not intend to take any picture.
2. In order to change the composition or for some reason, the photographer is trying to figure out the entire capturing space without looking through the camera.
3. The photographer lost the track of a target and is now trying to locate the target.

Based on the assumption derived from the above-described knowledge, a description is now given of the first embodiment of the present invention.

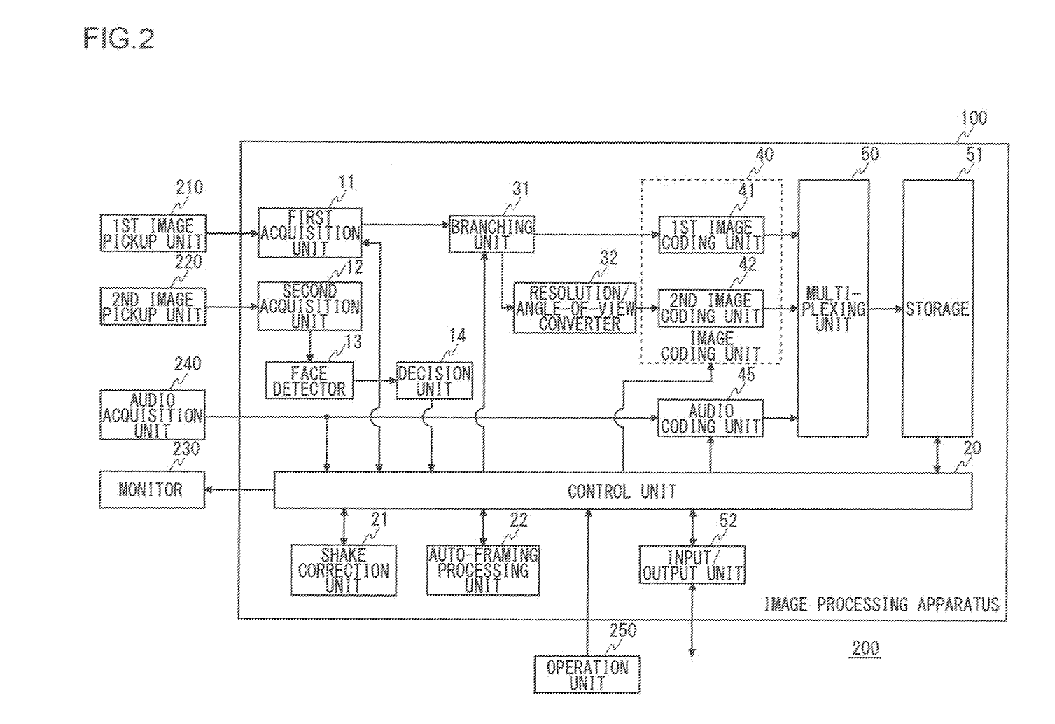

FIG. 2 shows a structure of an image pickup apparatus 200 provided with an image processing apparatus 100 according to the first embodiment of the present invention. The image pickup apparatus 1200 includes the first image pickup unit 210, the second image pickup unit 220, the monitor 230, an audio acquisition unit 240, an operation unit (control module) 250, and the image processing apparatus 100.

A detailed description is now given of the first image pickup unit 210. The first image pickup unit 210 acquires continuously frame images and then supplies the acquired frame images to the image processing apparatus 100 as the moving images. The first image pickup unit 210 includes solid-state image sensing devices, such as CCD (Charge-Coupled Devices) sensors and CMOS (Complementary Metal-Oxide Semiconductor) image sensors, and a not-shown signal processing circuit for processing signals outputted from the solid-state image sensing devices. The signal processing circuit converts analog ROB primary color signals outputted from the solid-state image sensing devices into digital luminance signal Y and digital color-difference signals Cr and Cb.

The second image pickup unit 220, which is basically the same as the first image pickup unit 210, may use those image sensing devices with lower specifications than the first image pickup unit 210. If the step of determining whether or not the photographer is viewing the monitor 230 is performed at certain time intervals (e.g., for every five seconds), the second image pickup unit 220 will not be necessarily equipped with a function capable of capturing the moving images but it will suffice if the second image pickup unit 220 can capture still images at certain time intervals. As for the resolution and the angle of view, the second image pickup unit 210 with lower specifications than the first image pickup unit 210 may be used.

The audio acquisition unit 240 converts the audio acquired externally into electrical signals and then outputs the converted signals to the image processing apparatus 100 as audio signals. The operation unit 250 receives user's instructions, then generates control signals based on the instructions and outputs the control signals to the image processing apparatus 100.

The image processing apparatus 100 includes a first acquisition unit 11, a second acquisition unit 12, a face detector 13, a decision unit 14, a control unit 20, a shake correction unit 21, an auto-framing processing unit 22, a branching unit 31, a resolution/angle-of-view converter 32, an image coding unit 40, an audio coding unit 45, a multiplexing unit 50, a recording unit 51, and an input/output unit 52. The image coding unit 40 includes a first image coding unit 41 and a second image coding unit 42.

The structure of the image processing apparatus 100 may be achieved hardwarewise by elements such as a given processor, memory and other LSIs, and softwarewise by memory-loaded programs or the like. Depicted herein are functional blocks implemented by cooperation of hardware and software. Therefore, it will be obvious to those skilled in the art that the functional blocks may be implemented by a variety of manners including hardware only, software only or a combination of both.

The first acquisition unit 11 acquires images from the first image pickup unit 210 and supplies the acquired images to the branching unit 31. The second acquisition unit 12 acquired images from the second image pickup unit 220 and supplies the acquired images to the face detector 13.

The face detector 13 detects the face of a person from within an image captured by the second image pickup unit 220. The face detection by the face detector 13 may be done using a commonly available method. For example, a face image may be detected from within a frame image using an identifier for identifying the face image. In the present embodiment, whether or not the photographer is watching the monitor 230 needs to be determined. Thus, the face detector 13 performs scanning to see if there is any face image confronting directly on the monitor 230, and supplies the scanning result to the decision unit 14.

The decision unit 14 determines whether or not the photographer is watching the monitor 230 that displays the moving images for use in recording acquired by the first acquisition 11, based on the images acquired by the second acquisition unit 12. More specifically, the scanning result is acquired from the face detector 13 and if the face image confronting directly on the monitor 230 is detected, it will be determined that the photographer is watching the monitor 230. If no face image confronting directly on the monitor 230 is detected, it will be determined that the photographer is not watching the monitor 230.

Since the face detector 13 performs the scanning repeatedly by enlarging and reducing the frame images, the size of the face image in the frame images is also detected. Thus, the distance between the photographer and the monitor 230 can be estimated based on the size of the face image. Also, if an identifier capable of identifying the seriousness of facial expression is used, whether the photographer viewing the monitor 230 is serious or relaxed can be determined. Note that a particular person is captured by any image pickup apparatuses and then a discriminator may be generated based on the person. If this discriminator is used, whether the person is viewing the monitor 230 or not can be determined. In such a case, even though another different person is actually watching the monitor 230, it is determined that no one is watching the monitor 230.

The control unit 20 varies the status of the image pickup apparatus 200 according to a decision result obtained by the decision unit 14. A specific example of this status variation will be discussed later.

According to the instructions fed from the control unit 20, the branching unit 31 outputs the moving images supplied from the first acquisition unit 11, to either the first image coding unit 41 or the resolution/angle-of-view converter 32 or outputs them to both the first image coding unit 41 and the resolution/angle-of-view converter 32.

The resolution/angle-of-view converter 32 can convert the resolution and/or the angle of view of frame images that constitute the moving images inputted from the branching unit 31. For example, the resolution of the frame images can be lowered; a central region of each of the frame images is cut out to remove its peripheral region, thereby narrowing the angle of view thereof. Also, the pixels in the frame images may be thinned out so as to lower the resolution and narrow the angle of view. The resolution/angle-of-view converter 32 outputs the moving images constituted by the frame images whose resolution and/or angle of view have/has been converted, to the second image coding unit 42.

Note that a super-resolution processing unit (not shown) may be provided between the resolution/angle-of-view converter 32 and the second image coding unit 42. This super-resolution processing unit may enhance the resolution of frame images, whose angle of view has been adjusted to a narrow angle of view by the resolution/angle-of-view converter 32, through a super-resolution processing so as to restore the original size of frame images. As a result, the size of the frame image, whose angle of view has been adjusted to a narrow angle in order to enlarge a region of interest, can be restored to the original size at the original resolution.

The image coding unit 40 can code the moving images acquired by the first image pickup unit 210, at both a first image quality and a second image quality, which is different from the first image quality, parallelly or simultaneously. In other words, a single kind of moving images can be dual-encoded. In FIG. 2, both the moving images inputted from the branching unit 31 and the moving images inputted from the resolution/angle-of-view converter 32 can be coded parallelly or simultaneously by the first image coding unit 31 and the second image coding unit 42, respectively.

The moving images of the first image quality and those of the second image quality are coded at different resolutions and/or different angles of view. For example, various types of combinations are available in the combinations of the resolution in the moving images of the first image quality and the resolution in those of the second image quality. For example, such a combination may be any two of 1920×1080 pixel size, 1280×720 pixel size, 640×480 Pixel size, 448×336 pixel size, and 192×108 pixel size.

Also, the moving images of the first image quality and those of the second image quality may be coded not only at different resolutions and/or different angles of view but also at different frame rates. For example, the moving images may be coded using a combination of any two of 60 fps, 30 fps, and 15 fps. Also, where the moving images are of a low resolution such as 448×336 pixel size or 192×108 pixel size, a higher frame rate such as 240 fps or 600 fps may be assigned.

The image coding unit 40 compresses and codes the moving images of the first image quality and those of the second image quality by complying with a predetermined standard. For example, the compression and coding may be carried out by complying with a standard such as H.264/AVC, H.264/SVC, MPEG-2, or MPEG-4.

The image coding unit 40 may code the moving images of the first image quality and those of the second image quality by the use of a single hardware encoder or a software process of a general-purpose processor in a time sharing manner. Alternatively, the image coding unit 40 may code the moving images of the first image quality and those of the second image quality in parallel by the use of two hardware encoders. The image coding unit 40 outputs the coded data of moving images of the first image quality and those of the second quality, which have been coded as above, to the multiplexing unit 50. Note here that the coded data is hereinafter referred to as “codestream” also.

The audio coding unit 45 codes audio signals supplied from the audio acquisition unit 240. For example, the audio signals are compressed and coded by complying with a standard such as AAC or MP3. The audio coding unit 45 outputs the coded data of audio signals coded, to the multiplexing unit 50.

The multiplexing unit 50 multiplexes the coded data of moving images of the first image quality inputted from the first image coding unit 41, the coded data of moving images of the second image quality inputted from the second image coding unit 42, and the coded data of audio signals inputted from the audio coding unit 45 so as to generate one file of moving images. For example, a container file may be generated compliant with an MP4 file format. This container file may contain a container describing the header information on each of the coded data, metadata, the time information and the like. Referencing this container file at a decoding side allows the moving images of the first image quality, those of the second image quality and the audio signals to be synchronized among them and allows an easy random access thereto.

The recording unit 51 records the file of moving images multiplexed by the multiplexing unit 50 in a predetermined recording medium. The recording medium used herein may be at least one of built-in memory and detachable removable memory. For example, a semiconductor memory or a hard disk may be used as the built-in memory. Also, a memory card, a removable hard disk or an optical disk may be used as the removable memory.

The input/output unit 52 communicates with an external device via a predetermined interface. For example, using a USB cable connected to a PC or a hard disk, the file of moving images recorded in the recording medium can be transferred to the PC or the hard disk. Using a cable connected to a D terminal, an S terminal or an HDMI terminal of a television set, the moving images of the first image quality and those of the second image quality can be displayed on a television screen.

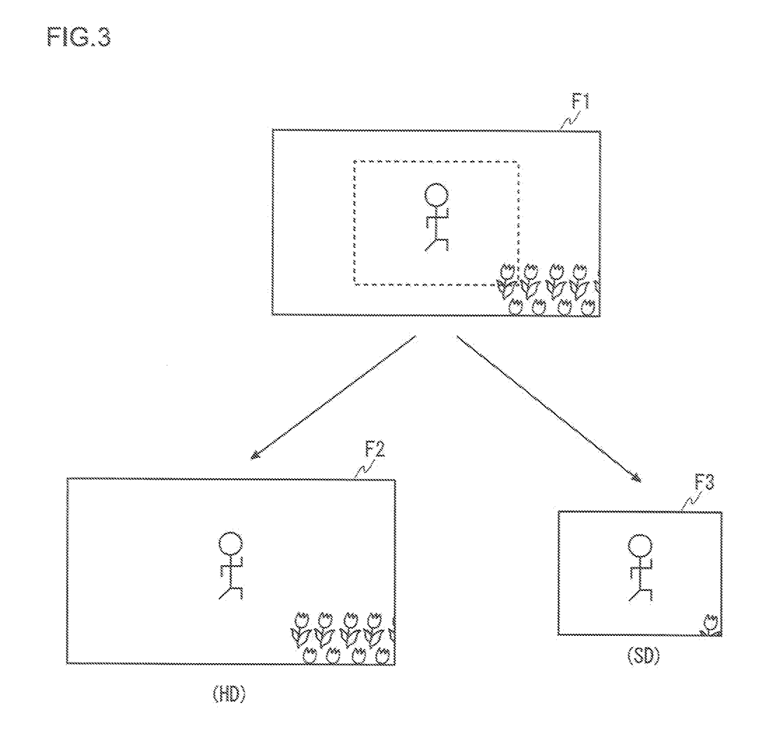

FIG. 3 illustrates relations among a frame image F1 inputted to the branching unit 31, a frame image F2 coded by the first image coding unit 41, and a frame image F3 coded by the second image coding unit 42. Referring to FIG. 3, a description is given of an exemplary case where the moving images of the first image quality are constituted by frame images of HD (1280×720 pixels) size and the moving images of the second image quality are constituted by frame images of SD (640×480 pixels) size. In this example, the frame image F1 of HD size is inputted to the branching unit 31.

The branching unit 31 outputs the image frame F1 of HD size to the first image coding unit 41 and the resolution/angle-of-view converter 32. The resolution/angle-of-view converter 32 converts the image frame F1 of HD size into the frame image F3 of SD size. The first image coding unit 41 codes the frame image F1 of HD size directly. The second image coding unit 42 codes the frame image F3 of SD size inputted from the resolution/angle-of-view converter 32.

The aspect ratio of the frame image F2 of HD size coded by the first image coding unit 41 is 16:9, whereas the aspect ratio of the frame image F3 of SD size coded by the second image coding unit 42 is 4:3. The frame image F3 of SD size is generated in such a manner that the central region of the frame image F2 of HD size remains intact and the peripheral region thereof is removed.

A description is hereunder given of specific examples where the above status is varied by the control unit 20. In a first concrete example, the on and off of a dual-encoding function is controlled. That is, the control unit 20 performs control such that when the decision result by the decision unit 14 indicates that the photographer is viewing the monitor 230, a plurality of coded data of moving images having mutually different image qualities are generated from the moving images acquired by the first acquisition unit 11. Also, the control unit 20 performs control such that when the decision result indicates that the photographer is not viewing the monitor 230, a single kind of coded data of moving images is generated from the moving images acquired by the first acquisition unit 11.

As described above, the image coding unit 40 can code the moving images acquired by the first acquisition unit 11, either (1) at both the first image quality and the second image quality lower than the first image quality or (2) at one of the first image quality and the second image quality. Using this function, the control unit 20 can perform control such that when the decision result by the decision unit 14 indicates that the photographer is viewing the monitor 230, two kinds of coded data of moving images using the first image quality and the second image quality are generated from the moving images acquired by the first acquisition unit 11. Also, the control unit 20 car perform control such that when the decision result indicates that the photographer is not viewing the monitor 230, a single kind of coded data of moving images using the second image quality is generated from the moving images acquired by the first acquisition unit 11. Also, the control unit 20 may perform control such that when the photographer is not viewing the monitor 230, a single kind of coded data of moving images using the first image quality is generated from the moving images acquired by the first acquisition unit 11.

Similar to FIG. 3, a description is hereunder given of an exemplary case where the moving images of the first image quality are constituted by frame images of HD (1280×720 pixels) size and the moving images of the second image quality are constituted by frame images of SD (640×480 pixels) size.

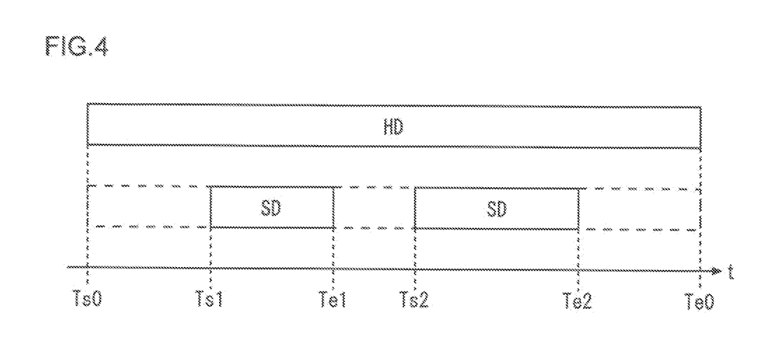

FIG. 4 illustrates an exemplary switching timing between a single codec mode, in which the moving images are coded at the HD image quality, and a dual encode mode, in which the moving images are coded at the HD image quality and the SD image quality. In this example, the moving images of HD image quality are coded during a total shooting period, and both the moving images of HD image quality and those of SD image quality are coded during a period, in the total shooting period, when the decision unit 14 determines that the photographer is watching the monitor 230 (hereinafter this period will be referred to as “period of interest”). That is, the image coding unit 40 continuously codes the captured moving images at the HD image quality and intermittently codes them at the SD image quality.

This example is suitable to a case where the main purpose thereof is to store high-quality moving images for use in viewing on the PC or television set and a secondary purpose thereof is to send a part of the moving images by attaching them to electronic mail or posting them at a site on the Internet.

In FIG. 4, two periods of interest are set in the total shooting period. The shooting starts at shooting start timing Ts0 and a single codec at the HD image quality starts. Subsequently, a dual encode mode at the HD image quality and the SD image quality starts at first period-of-interest start timing Ts1. Then, the dual encoding at the HD image quality and the SD image quality ends at first period-of-interest end timing Te1, and a single code at the HD image quality starts. Then, a dual encode mode at the HD image quality and the SD image quality starts at second period-of-interest start timing Ts2. Then, the dual encoding at the HD image quality and the SD image quality ends at second period-of-interest end timing Te2, and a single code at the HD image quality starts. Finally, the shooting ends at shooting end timing Te0, and the single codec ends.

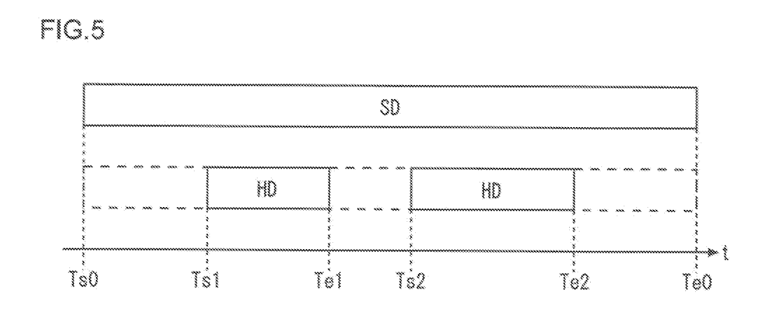

FIG. 5 illustrates an exemplary switching timing between a single codec mode, in which the moving images are coded at the SD image quality, and a dual encode mode, in which the moving images are coded at the HD image quality and the SD image quality. In this example, the moving images of SD image quality are coded during the total shooting period, and both the moving images of HD image quality and those of SD image quality are coded during a period of interest in the total shooting period. That is, the image coding unit 40 continuously codes the captured moving images at the SD image quality and intermittently codes them at the HD image quality.

This example is suitable to a case where the main purpose thereof is to send the whole of the captured moving images by attaching it to electronic mail or posting it at a site on the Internet and a secondary purpose thereof is to store a part of the moving images for use in viewing on the PC or television set.

Since the example shown in FIG. 5 is similar to the example of FIG. 4 except that the HD image quality is replaced by the SD image quality. That is, the shooting starts at shooting start timing Ts0 and a single codec at the SD image quality starts. Subsequently, a dual encode mode at the SD image quality and the HD image quality starts at first period-of-interest start timing Ts1. Then, the dual encoding at the SD image quality and the HD image quality ends at first period-of-interest end timing Te1, and a single code at the SD image quality starts. Then, a dual encode mode at the SD image quality and the HD image quality starts at second period-of-interest start timing Ts2. Then, the dual encoding at the SD image quality and the HD image quality end at second period-of-interest end timing Te2, and a single code at the SD image quality starts. Finally, the shooting ends at shooting end timing Te0, and the single codec ends.

A description is now given of a second concrete example where the above status is varied by the control unit 20. In the second concrete example, the on and off of a shake correction function or the level of shake correction is controlled. That is, the control unit 20 performs control such that when the decision result by the decision unit 14 indicates that the photographer is viewing the monitor 230, the shake correction function is turned on or the level of shake correction is lowered. Also, the control unit 20 performs control such that when the decision result indicates that the photographer is not viewing the monitor 230, the shake correction function is turned on or the level of shake correction is raised.

Referring back to FIG. 2, the shake correction unit 21 performs a commonly available electronic shake correction in response to instructions sent from the control unit 20. That is, the frame images for the entire image pickup range acquired from the acquisition unit 11 are stored temporarily and an effective region is selected from within the frame image. More specifically, a shift amount between a given frame and a frame differing from said given frame in the temporal direction is calculated, and the effective region is so moved as to cancel out the shift amount.

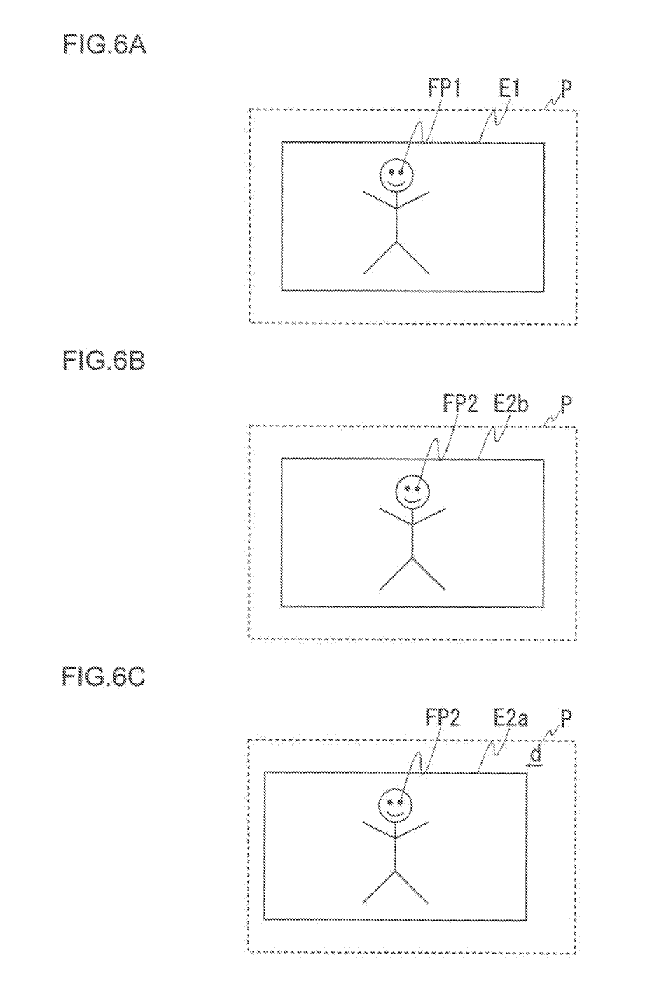

FIGS. 6A to 6C illustrate an example where the shake correction unit 21 performs a shake correction. FIG. 5A is a frame image immediately before the current frame image. FIG. 5B is the current frame image before the correction. FIG. 6C is the current frame image after the correction. A image pickup range P is fixed over the entire shooting period.

An image of a person as an object is captured within an effective region E1 shown in FIG. 6A. In this case, the person's left eye is set as a feature point FP1 of a frame image. As compared with the frame image immediately before the current frame image, a feature point FF2 (see FIG. 6B) in an effective region E2b of a frame image is moved by a predetermined distance to the right. Thus, in order to cancel out this movement as shown in FIG. 6C, an effective region E2a of the current frame is moved by distance d to the left. This corrects the shake.

Note here that the amount of compensation corresponding to the shift amount does not need to match completely with the shift amount and therefore the level of shake correction may be adjusted to 50 or 80%, for instance. For example, when the decision result by the decision unit 14 indicates that a particular photographer, who is not very familiar with the image-taking actions and is registered beforehand, is watching the monitor 230, the shake correction function may be set to ON at the level of 50% or above.

A description is now given of a third concrete example where the above status is varied by the control unit 20. In the third concrete example, the on and off of a auto-framing function is controlled. That is, the control unit 20 performs control such that when the decision result by the decision unit 14 indicates that the photographer is viewing the monitor 230, the auto-framing function is turned off. Also, the control unit 20 performs control such that when the decision result indicates that the photographer is not viewing the monitor 230, the auto-framing function is turned on.

Referring back to FIG. 2, the auto-framing processing unit 22 performs a commonly available auto-framing process in response to instructions sent from the control unit 20. That is, the position of a target object lying within a region to be trimmed from the frame image is fixed. More specifically, the region to be trimmed from within the frame image is adaptively moved even though the object moves within the frame image or the orientation of a camera varies; control is performed so that the position of the object detected at first within the frame image can be maintained within a recording image. In the present embodiment, the frame images acquired from the first acquisition unit 11 are stored temporarily, and a trimming region to be outputted to the branching unit 31 is selected.

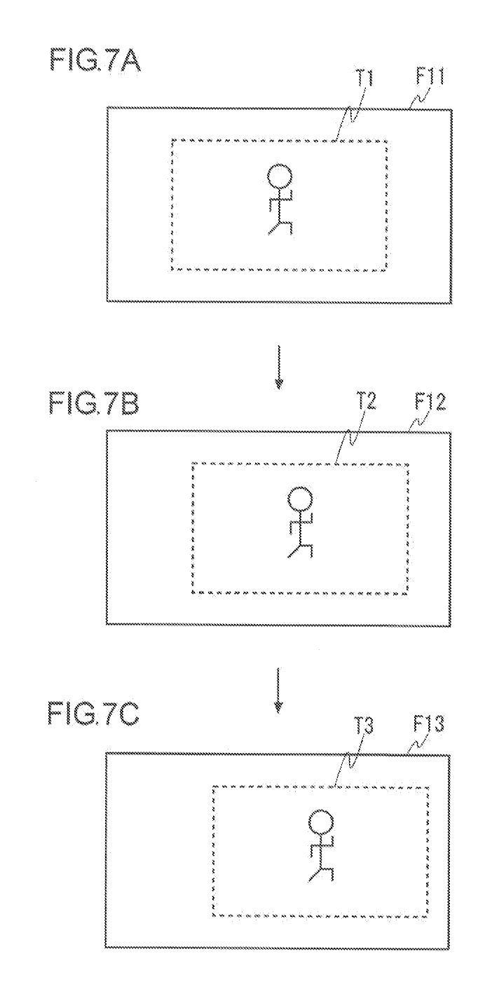

FIGS. 7A to 7C illustrate an example where the auto-framing processing unit 22 performs an auto-framing process. FIG. 7A is a frame image F11 which is a frame image from two frames preceding the current frame image F13. FIG. 7B is a frame image F12 immediately before the current frame image F13. FIG. 70 is the current frame image F13.

FIGS. 7A to 7B illustrate an example where a person, who is to be treated an object here, is moving to the right. Trimming regions T1 to T3 move to the right in accordance with the movement of the person so that the person, who is to be treated as the object, can be positioned in the center in each trimming region. As a result, the moving image for which the person is captured in the center thereof can be recorded.

A description is now given of a fourth concrete example where the above status is varied by the control unit 20. In the fourth concrete example, whether the audio to be recorded is to be given a directive property or not is controlled. That is, the control unit 20 performs control such that when the decision result by the decision unit 14 indicates that the photographer is viewing the monitor 230, the audio data is recorded with the directive property attached to the audio. Also, the control unit 20 performs control such that when the decision result indicates that the photographer is not viewing the monitor 230, the audio data is recorded with no directive property attached to the audio.

More specifically, the control unit 20 has the audio coding unit 45 code the obtained audio such that when the photographer is viewing the monitor 230, the level of audio obtained from a direction that the first image pickup unit 210 faces is greater than the level of audio obtained from the other directions. For example, the level of audio obtained from directions other than the direction that the first image pickup unit 210 faces is attenuated. On the other hand, the control unit 20 processes uniformly the audios obtained from all the directions and has the audio coding unit 45 code them.

A description is now given of a fifth concrete example where the above status is varied by the control unit 20. In the fifth concrete example, whether the coding of the captured moving images and/or the recording thereof are/is to be performed or not is controlled. That is, the control unit 20 performs control such that when the decision result by the decision unit 14 indicates that the photographer is not viewing the monitor 230, the coding of the captured moving images and/or the recording thereof are/is stopped. Or, the power supply of the image pickup apparatus 200 as a whole is turned off or the mode of the image pickup apparatus 200 is shifted to a power saving mode. On the other hand, when the photographer is viewing the monitor 230, the coding of the captured moving images and/or the recording thereof are/is started again. Or, the power supply of the image pickup apparatus 200 as a whole is turned on from the off state or the mode of the image pickup apparatus 200 is returned to a normal mode from the power saving mode.

A description is now given of a sixth concrete example where the above status is varied by the control unit 20. In the sixth concrete example, the coding bit rate of the moving images is controlled. That is, the control unit 20 performs control such that when the decision result by the decision unit 14 indicates that the photographer is viewing the monitor 230, the coding bit rate of the captured moving images is kept intact or raised. Also, the control unit 20 performs control such that when the decision result indicates that the photographer is not viewing the monitor 230, the coding bit rate of the captured moving images is lowered.

Note that when the bit rate is controlled, the aforementioned seriousness of facial expression detected by the face detector 13 may be taken into account. When the photographer is viewing the monitor 230, the control unit 20 may perform control such that the higher the seriousness is, the higher the bit rate becomes. For example, the seriousness and the bit rate may be related to each other such that the bit rate is proportional to the level of seriousness.

A description is now given of a seventh concrete example where the above status is varied by the control unit 20. In, the seventh concrete example, whether the on/off of the power of the monitor 230 is controlled. That is, the control unit 20 performs control such that when the decision result by the decision unit 14 indicates that the photographer is viewing the monitor 230, the power of the monitor 230 is turned on. Also, the control unit 20 performs control such that when the decision result indicates that the photographer is not viewing the monitor 230, the power of the monitor 230 is turned off. For example, where the monitor 230 is a LCD monitor, the on/off of the backlight of the LCD monitor is controlled.

According to the first embodiment as described above, the status of the image pickup apparatus 200 is controlled according to whether the photographer is viewing the monitor 230 or not, so that the image-taking actions of the photographer can be supported. In the first concrete example, the dual-encoding of the moving images allows the generation of the coded data of moving images having two kinds of image qualities. For example, both a request, in which a scene required is recorded with two kinds of image qualities, and a request, in which an increase in data volume is suppressed, are automatically met without involving any user's operation, when the coded data of moving images having two kinds of image qualities are generated. As for the above-described second to seventh concrete examples, the mode can be automatically set to a mode suitable for the image-taking conditions without involving the user's operations.

The description of the present invention given above is based upon the first embodiment. This embodiment is intended to be illustrative only and it will be obvious to those skilled in the art that various modifications to constituting elements and processes could be developed and that such modifications are also within the scope of the present invention.

In the above-described first embodiment, a description has been given of an example where the image coding unit 40 is constituted by two coding units. However, the present embodiment is not limited thereto and the image coding unit 40 may be constituted by a single coding unit instead. In such a case, the second to seventh concrete examples are still applicable though the first concrete example is not.

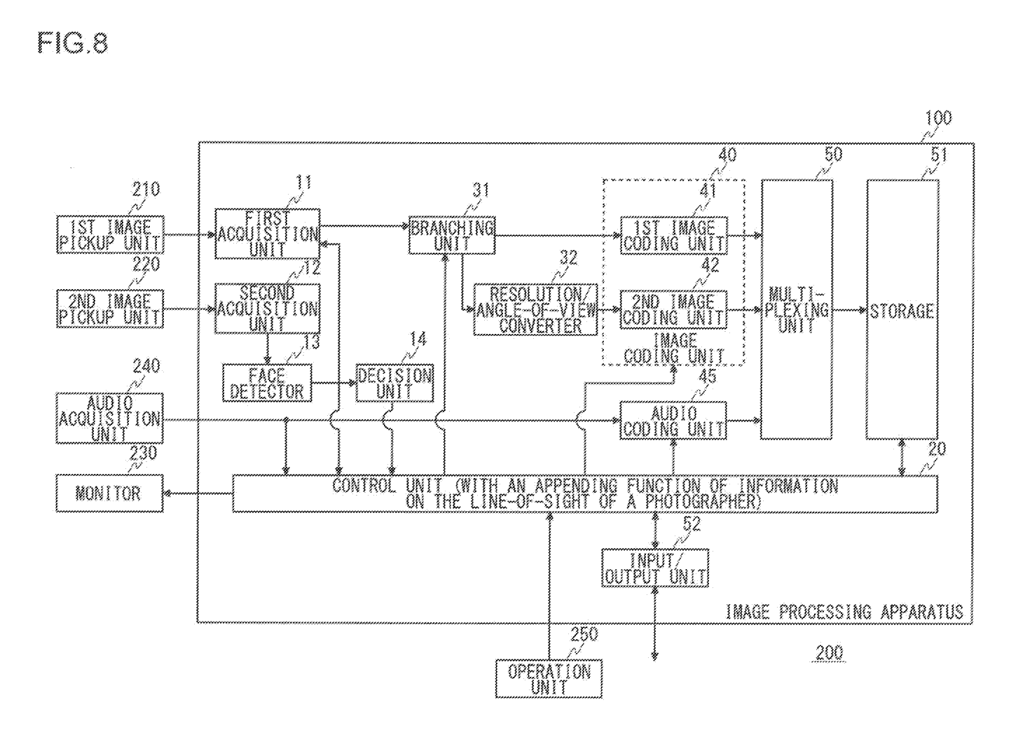

FIG. 8 shows a structure of an image pickup apparatus 200 provided with an image processing apparatus 100 according to a second embodiment of the present invention. The image pickup apparatus 200 includes a first image pickup unit 210, a second image pickup unit 220, a monitor 230, an audio acquisition unit 240, an operation unit (control module) 250, and an image processing apparatus 100.

The image processing apparatus 100 includes a first acquisition unit 11, a second acquisition unit 12, a face detector 13, a decision unit 14, a control unit 20, a branching unit 31, a resolution/angle-of-view converter 32, an image coding unit 40, an audio coding unit 45, a multiplexing unit 50, a recording unit 51, and an input/output unit 52. The image coding unit 40 includes a first image coding unit 41 and a second image coding unit 42. The description of the components similar to those of the image processing unit 100 according to the first embodiment is omitted as appropriate.

According to the decision result obtained by the decision unit 14, the control unit 20 generates information, on the line-of-sight of the photographer, which is used to specify whether the photographer is viewing the monitor 230 or not, and appends this information to the coded data of moving images generated by the image coding unit 40.

According to the second embodiment as described above, the information indicating whether the photographer is viewing the monitor 230 or not is appended to the coded data of moving images, so that the information useful at a decoding and playback side can be supplied. Though in the image processing apparatus 100 shown in FIG. 8 a description has been given of an example where the image coding unit 40 is constituted by two coding units, the image coding unit 40 may be constituted by a single coding unit instead. In other words, the image processing apparatus 100 may be structured such that only a single kind of coded data of moving images is generated.

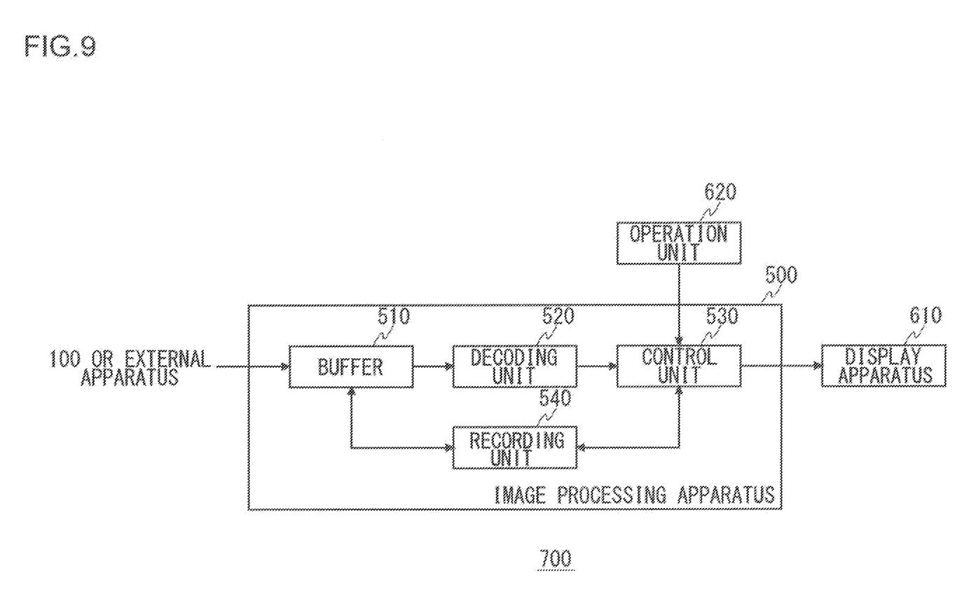

FIG. 9 shows a structure of an image display system 700 provided with an image processing apparatus 500 according to a third embodiment of the present invention. The image display system 700 includes an image processing apparatus 500, a display apparatus 610, and an operation apparatus 620.

The image display system 700 may be configured by various pieces of hardware. For example, the image display system 700 may be configured by the above-described image pickup apparatus 200 and a television set connected thereto using a cable. In this case, the image processing apparatus 500, the operation unit 620, and the display apparatus 610 may be configured by a control function of the image pickup apparatus 200, the operation unit 250 in the image pickup apparatus 200, and a display function of the television set, respectively.

Also, the image display system 700 may be configured by a PC that has received the file of moving images generated by the image processing apparatus 100 according to the second embodiment. In this case, the image processing apparatus 500, the operation unit 620, and the display apparatus 610 may be configured by a control function, a control module function, and a display function of the PC, respectively. The same configuration may be applicable when a mobile phone, a smart phone, mobile music player, a game device and the like are used in the place of the PC.

Also, the image display system 700 may be configured by a single body of the above-described image pickup apparatus 200. In this case, the image processing apparatus 500, the operation unit 620, and the display apparatus 610 may be configured by a control function, a control module function, and a display function of the image pickup apparatus 200, respectively. The image processing apparatus 100 according to the second embodiment may also be included in this image pickup apparatus 200.

The display apparatus 610 displays the moving images supplied from the image processing apparatus 500. The operation unit 620 receives user's instructions, then generates control signals based on the instructions, and outputs the control signals to the image processing apparatus 500.

The image processing apparatus 500 according to the third embodiment reproduces, edits or stores the coded data of moving images which have been generated by the image processing apparatus 100 according to the second embodiment and which have been related to the information on the line-of-sight of the photographer. The image processing apparatus 500 according to the third embodiment includes a buffer 510, a decoding unit 520, a control unit 530, and a recording unit 540.

The structure of the image processing apparatus 500 may be achieved hardwarewise by elements such as any processor, memory and other LSIs, and softwarewise by memory-loaded programs or the like. Depicted herein are functional blocks implemented by cooperation of hardware and software. Therefore, it will be obvious to those skilled in the art that the functional blocks may be implemented by a variety of manners including hardware only, software only or a combination of both.

The buffer 510 stores temporarily the coded data of moving images generated by the image processing apparatus 100 according to the second embodiment. The coded data of moving images may be inputted from the recording unit 51 in the image processing apparatus 100, inputted from an external storage device (e.g., memory card, external hard disk, or the like) located external to the image pickup apparatus 200 and the image processing apparatus 500 inputted from the recording unit 540 in the image processing apparatus 500. The buffer 510 supplies said coded data of moving images to the decoding unit 520 with predetermined timing.

The decoding unit 520 decodes the coded data of moving images supplied from the buffer 510 and supplies the decoded data thereof to the control unit 530. The recording unit 540 mainly records the coded data of moving images. The coded data of moving images which have been generated by the image processing apparatus 100 according to the second embodiment and which have been related to said information on the line-of-sight of the photographer can be recorded as well. The coded data of moving images after having been edited by the control unit 530 can be recorded as well.

The control unit 530 can perform various kinds of processings such as the playback control, editing, deleting and file management of the coded data of moving images related to said information on the line-of-sight of the photographer.

A description is first given of a first exemplary operation performed by the control unit 530. In the first exemplary operation, the control unit 530 cues up or accesses a position, identified by said information on the line-of-sight of the photographer, where the photographer starts to view the monitor 230. Or, the control unit 530 performs control such that a digest is played back by joining together the periods during which the photographer is viewing the monitor 230.

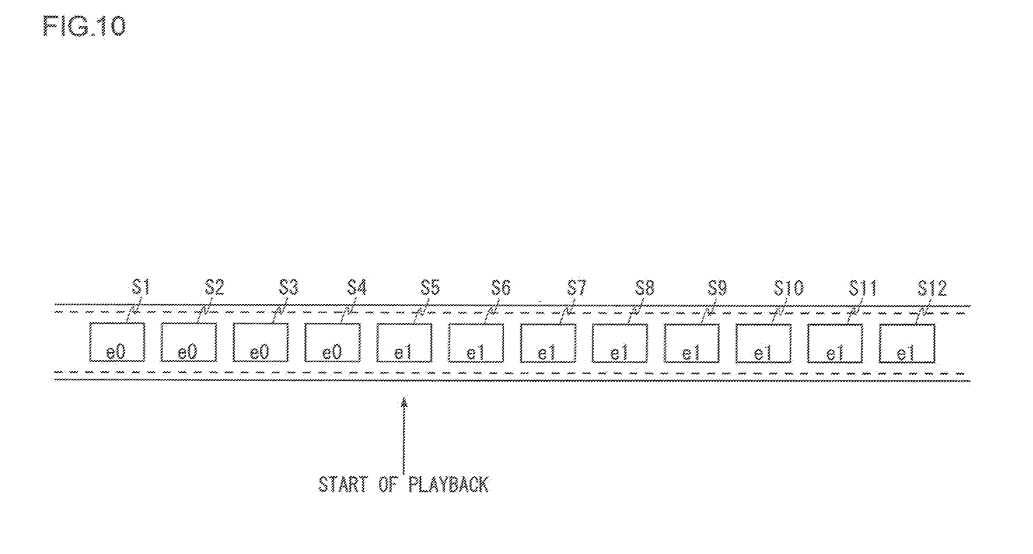

FIG. 10 is a diagram to explain an access (cue) playback control performed by the control unit 530 according to the third embodiment. Moving images shown in FIG. 10 are constituted by a first scene S1 to a twelfth scene S12. Each frame in FIG. 10 indicates a beginning frame of each scene. “e0” or “e1” indicated in each frame is information indicating whether or not the photographer was viewing the monitor 230 when each scene was captured. “e0” indicates that the photographer was not viewing the monitor 230, whereas “e1” indicates that he/she was viewing the monitor 230. It is assumed herein that the state where the photographer was viewing or not viewing the monitor 230 does not change during each scene. It goes without saying that each processing performed by the control unit 530 according to the third embodiment is also applicable to a structure in which the state, where the photographer is viewing the monitor 230, and the state, where the photographer is not viewing the monitor 230, are switchable therebetween per scene.

The example shown in FIG. 10 indicates that the photographer was not viewing the monitor 230 up to the fourth scene 94 while the scenes were being captured. Thus, the control unit 530 determines that the scenes up to the fourth scene 94 are not important, and performs control in such a manner as to play back the scenes starting from the fifth scene 95 onward.

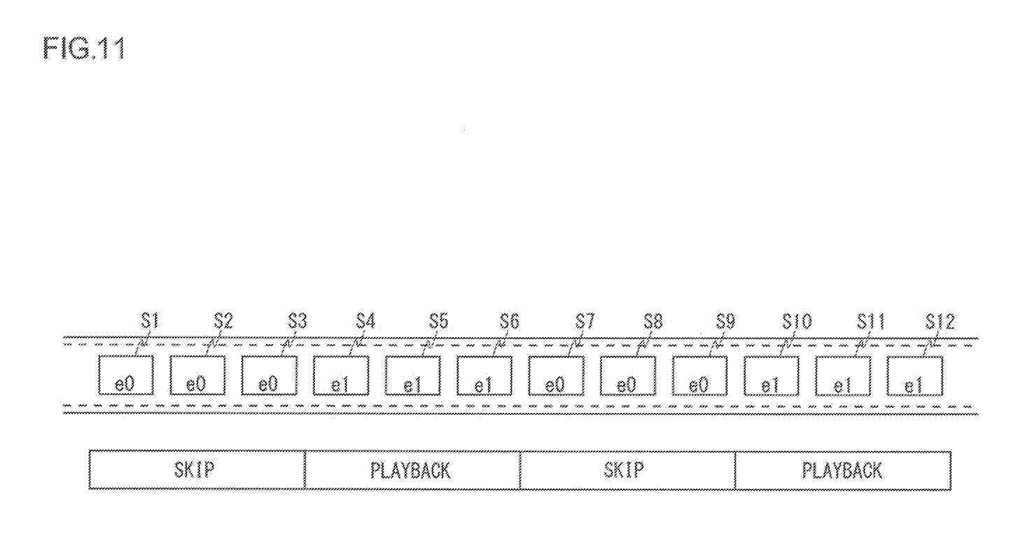

FIG. 11 is a diagram to explain a digest playback control performed by the control unit 530 according to the third embodiment. The example shown in FIG. 11 indicates that the photographer was not viewing the monitor 230 from the first scene S1 to the third scene 93 and also from the seventh scene 97 to the ninth scene 99 when the scenes were being captured. This example shown in FIG. 10 also indicates that the photographer was viewing the monitor 230 from the fourth scene S4 to the sixth scene S6 and also from the tenth scene S10 to the twelfth scene S12 when the scenes were being captured.

Thus, the control unit 530 determines that the scenes from the first scene S1 to the third scene S3 and those from the seventh scene S7 to the ninth scene S9 are not important, and skips these six scenes. And the control unit 530 performs control such that a digest is played back by joining together the scenes from the fourth scene S4 to the sixth scene S6 and those from the tenth scene S10 to the twelfth scene S12.

A description is now given of a second exemplary operation performed by the control unit 530. In the second exemplary operation, the control unit 530 deletes a part of the moving images corresponding to periods, identified by said information on the line-of-sight of the photographer, during which the photographer is not viewing the monitor 230. Or, the control unit 530 deletes the entire moving images when the moving images decoded by the decoding unit 520 contain the periods, identified by said information on the line-of-sight of the photographer, during which the photographer is not viewing the monitor 230.

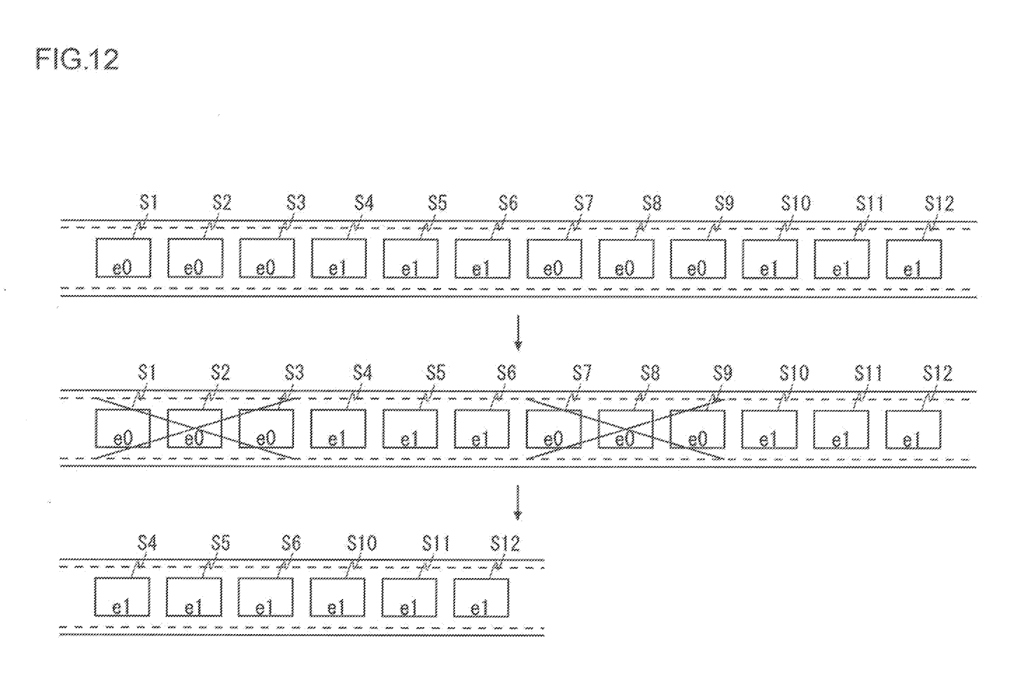

FIG. 12 is a diagram to explain an automatic editing control performed by the control unit 530 according to the third embodiment. Similar to the example shown in FIG. 11, the example shown in FIG. 12 indicates that the photographer was not viewing the monitor 230 from the first scene S1 to the third scene S3 and also from the seventh scene S7 to the ninth scene S9, and also indicates that the photographer was viewing the monitor 230 from the fourth scene S4 to the sixth scene S6 and also from the tenth scene S10 to the twelfth scene S12.

Thus, the control unit 530 determines that the scenes from the first scene S1 to the third scene S3 and those from the seventh scene S7 to the ninth scene S9 are not important, and deletes these six scenes. And the control unit 530 creates a new file of moving images by joining together the scenes from the fourth scene S4 to the sixth scene S6 and those from the tenth scene S10 to the twelfth scene S12. The data volume of this new file of moving images is reduced and therefore is less than the data volume of the file thereof before the editing. When the data volume is reduced according to the second exemplary operation, the editing can be done so that as many important scenes as possible can be saved or kept intact.

In the example shown in FIG. 12, only the scenes while the photographer was not viewing the monitor 230 are deleted. In a modification, if there is at least one scene, contained in the moving images, which is not viewed by the photographer through the monitor 230, the entire moving images contained such at least one scene may be deleted. If any file needs to be deleted from a plurality of files of moving images, this technique can be used to delete a relatively unimportant file or files.

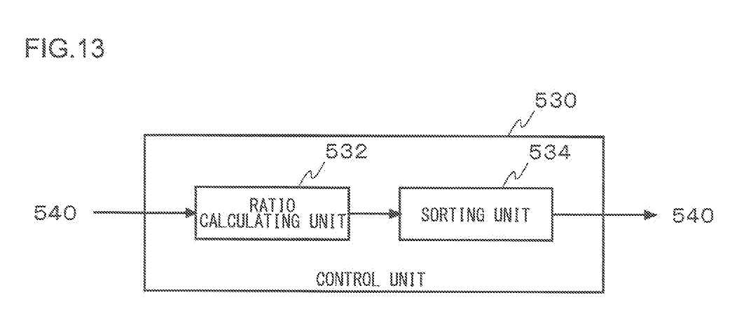

A description is now given of a third exemplary operation performed by the control unit 530. FIG. 13 shows a structure of the control unit 530 according to the third exemplary operation. The control unit 530 includes a ratio calculating unit 532 and a sorting unit 534. The ratio calculating unit 530 calculates the ratio of a viewing period aver a non-viewing period for each of a plurality of coded data of moving images stored in the recording unit 540. Here, the viewing period is a period, identified by said information on the line-of-sight of the photographer, during which the photographer is viewing the monitor 230, and the non-viewing period is a period, identified by said information on the line-of-sight of the photographer, during which the photographer is not viewing the monitor 230. The sorting unit 534 sorts out the plurality of coded data of moving images in the order starting from coded data whose calculated ratio is maximum or minimum.

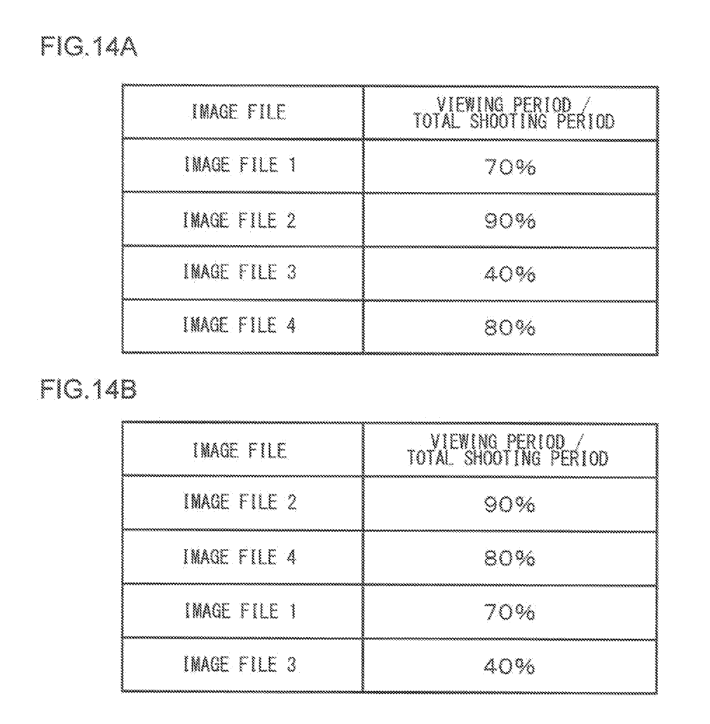

FIGS. 14A and 14B are diagrams to explain the file sorting performed by the control unit 530 according to the third embodiment. It is assumed in FIGS. 14A and 14B that four files of moving images are stored in the recording unit 540. FIG. 14A shows that four files of moving images are stored in the order of old-to-new or new-to-old recording time. In this case, when these four files of moving images are displayed on a screen of the display apparatus 610, a first file 1 of moving images, a second file 2 of moving images, a third file 3 of moving images, and the fourth file 4 of moving images are displayed in this order.

The ratio calculating unit 532 calculates the ratio of the viewing period, during which the photographer is viewing the monitor 230, over the total shooting period for each of the aforementioned four files of moving images. In FIG. 14A, the ratio of the viewing period over the total shooting period for the first file 1 of moving images is 70%, the ratio thereof for the file 2 of moving images 90%, the ratio thereof for the third file 3 of moving images 40%, and the ratio thereof for the fourth file 4 of moving images 80%.

FIG. 14B shows the result after the four files of moving images have been sorted out by the sorting unit 534. In FIG. 14B, the four files of moving images are sorted out in descending order of ratio, namely, in the order of the second file 2 of moving images, the fourth file 4 of moving images, the first file 1 of moving images, and the third file 3 of moving images. Thus, when these four files of moving images are display on the screen of the display apparatus 610, they are displayed in the order of the second file 2 of moving images, the fourth file 4 of moving images, the first file 1 of moving images, and the third file 3 of moving images. That is, the files of moving images can be displayed in the order starting from the highest degree of importance or attention estimated.

A description is now given of a fourth exemplary operation performed by the control unit 530. In the fourth exemplary operation, the control unit 530 plays back the moving images with the sound volume raised, for a period, identified by said information on the line-of-sight of the photographer, during which the photographer is viewing the monitor 230. And the control unit 530 plays them back with the sound volume lowered, for a period, identified by said information on the line-of-sight of the photographer, during which the photographer is not viewing the monitor 230. For example, where the two kinds of sound volume are set, the larger sound volume is selected during the former period and the lower sound volume is selected during the latter period.

Also, the control unit 530 amplifies the audio at the front facing the first image pickup unit 210 and plays back a part of the moving images decoded by the decoding unit 520, using a zoom mode in which the audio other than that in the front is reduced, for a period, identified by said information on the line-of-sight of the photographer, during which the photographer is viewing the monitor 230. And the control unit 530 plays back a part thereof, using a wide mode in which the audio is neither amplified nor reduced depending on the directions, for a period, identified by said information on the line-of-sight of the photographer, during which the photographer is not viewing the monitor 230. As a result, the moving images can be played back in such a manner that what a person captured at the front says can be further emphasized, for instance.

A description is now given of a fifth exemplary operation performed by the control unit 530. In the fifth exemplary operation, the control unit 530 plays back the moving images decoded by the decoding unit 520 for a period, identified by said information on the line-of-sight of the photographer, during which the photographer is viewing the monitor 230 in such a manner that an object to be targeted within the screen is emphasized. And the control unit 530 plays back the moving images decoded by the decoding unit 520 for a period, identified by said information on the line-of-sight of the photographer, during which the photographer is not viewing the monitor 230 in such a manner that the captured image as a whole can be displayed as much as possible.

For example, the control unit 530 can play back the moving images by zooming them in or out. More telescopic images are played back while the photographer is viewing the monitor 230, whereas wider-angle images are played back while he/she is not viewing the monitor 230. For example, where two kinds of angles of view are set, a telescopic angle-of-view is selected during the former period and a wide angle-of-view is selected during the latter period. If the region where the face image has been detected is set as a region of interest by the face detector 13 of the image processing apparatus 100 according to the above-described second embodiment and if the position and the size of the region of interest for each frame image are identified and the information on the position and the size thereof is appended to the coded data of moving images, the following process may be performed. In other words, the control unit 530 plays back the region of interest in a period during which the photographer is viewing the monitor 230, whereas the control unit 530 plays back the entire region in a period during which he/she is not viewing the monitor 230. Note that the region of interest may be set to positions including objects other than the face.

Also, The control unit 530 can play back the moving images using an auto-framing technique. An auto-framing playback function is turned on in a period during which the photographer is viewing the monitor 230, whereas the auto-framing function is turned off in a period during which he/she is not viewing the monitor 230.

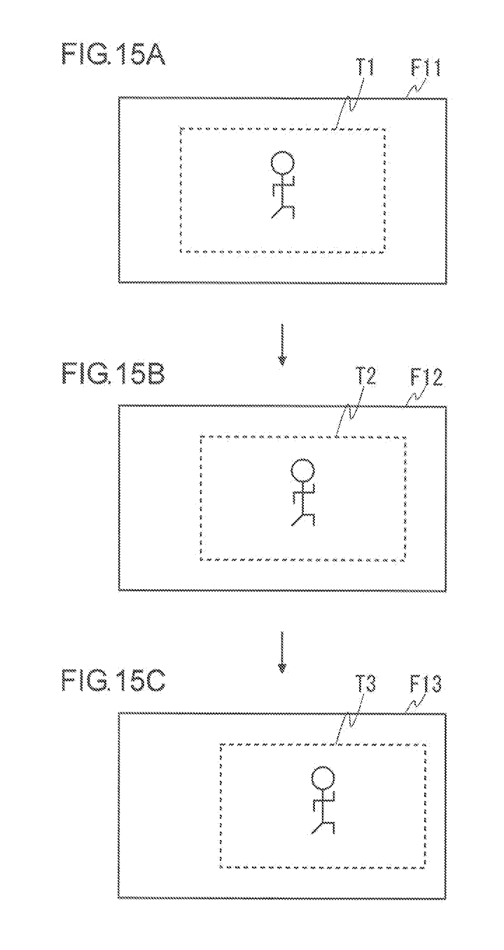

FIGS. 15A to 15C are diagrams showing an example of auto-framing playback processing performed by the control unit 530 according to the third embodiment. FIG. 15A is a frame image F11 which is a frame image from two frames preceding the current frame image F13. FIG. 15B is a frame image F12 immediately before the current frame image F13. FIG. 15C is the current frame image F13.

FIGS. 15A to 15C illustrate an example where a person, who is to be treated an object here, is moving to the right. Trimming regions T1 to T3 move to the right in accordance with the movement of the person so that the person, who is to be treated as the object, can be positioned in the center in each trimming region. These trimming regions T1 to T3 are set as playback regions. As a result, the moving images where the person is captured in the center can be played back.

According to the third embodiment as described above, the information indicating whether the photographer is viewing the monitor 230 or not is utilized. Hence, the playback and the editing of the moving images captured by the image pickup apparatus 200 can be supported, thereby saving a lot of time and many steps.

The description of the present invention given above is based upon the second and third embodiments. These embodiments are intended to be illustrative only and it will be obvious to those skilled in the art that various modifications to constituting elements and processes could be further developed and that such additional modifications are also within the scope of the present invention.

Assumed mainly in the above-described third embodiment is a case where a single kind of coded data of moving images are generated by the image processing apparatus 100. If plurality kinds of coded data of moving images are generated by the image processing apparatus 100, the following process may be performed. That is, the control unit 530 plays back the data of the highest image quality (e.g., HD image quality) in the moving images, decoded by the decoding unit 520, for a period, identified by said information on the line-of-sight of the photographer, during which the photographer is viewing the monitor 230, and plays back the data of lower image quality (e.g., SD image quality) in the moving images, decoded by the decoding unit 520, for a period, identified by said information on the line-of-sight of the photographer, during which the photographer is not viewing the monitor 230.

As a result, the load of the decoding unit as a whole can be reduced while the scene having a high degree of importance or attention are played back at a high quality.

What is claimed is:

1. An image processing apparatus mounted on an image pickup apparatus that picks up moving images, comprising:
a first acquisition unit configured to acquire an image from a first image pickup unit that picks up a moving image for use in recording;
a second acquisition unit configured to acquire an image from a second image pickup unit that picks up an image of a person taking the moving images;
a decision unit configured to determine whether or not the person taking the moving image is viewing a monitor that displays the moving image for use in recording, based on the image acquired from said second acquisition unit; and
a control unit configured to vary a status of the image pickup apparatus according to a decision result of said decision unit.

2. An image processing apparatus according to claim 1, wherein said control unit performs control such that when the decision result indicates that the person taking the moving image is viewing the monitor, a plurality of coded data of moving images having mutually different image qualities are generated from the moving images acquired by said first acquisition unit, and
when the decision result indicates that the person taking the moving image is not viewing the monitor, a single kind of coded data of moving images is generated from the moving images acquired by said first acquisition unit.

3. An image processing apparatus according to claim 2, further comprising a coding unit configured to be able code the moving images acquired by said first acquisition unit, either (1) at both a first image quality and a second image quality lower than the first image quality or (2) at one of the first image quality and the second image quality,
wherein said control unit performs control such that when the decision result indicates that the person taking the moving image is viewing the monitor, two kinds of coded data of moving images using the first image quality and the second image quality are generated from the moving images acquired by said first acquisition unit, and
when the decision result indicates that the person taking the moving image is not viewing the monitor, a single kind of coded data of moving images using the first image quality or the second image quality is generated from the moving images acquired by said first acquisition unit.

4. An image processing apparatus according to claim wherein said control unit performs control such that when the decision result indicates that the person taking the moving image is viewing the monitor, a shake correction function is turned off or a level of shake correction is lowered, and
when the decision result indicates that the person taking the moving image is not viewing the monitor, the shake correction function is turned on or the level of shake correction is raised.

5. An image pickup apparatus, comprising:
a first image pickup unit configured to pick up a moving image for use in recording;
a second image pickup unit configured to pick up an image of a person taking the moving image; and
an image processing apparatus according to claim 1.

6. An image processing apparatus, comprising:
a first acquisition unit configured to acquire an image from a first image pickup unit that picks up a moving image for use in recording;
an image coding unit configured to code the image acquired by said first acquisition unit so as to generate coded data of moving images;
a second acquisition unit configured to acquire an image from a second image pickup unit that picks up an image of a person taking the moving image;
a decision unit configured to determine whether or not the person taking the moving image is viewing a monitor that displays the moving image for use in recording, based on the image acquired from said second acquisition unit; and
an appending unit configured to relate information on a line-of-sight of the person taking the moving image to the coded data of moving image wherein the line-of-sight information specifies whether the person taking the moving image is viewing the monitor or not.

7. An image pickup apparatus, comprising:
a first image pickup unit configured to pick up a moving image for use in recording;
a second image pickup unit configured to pick up an image of a person taking the moving image; and
an image processing apparatus according to claim 6.

8. An image processing apparatus that reproduces the coded data of moving image generated by an image processing apparatus according to claim 6, the coded data of moving image being related to the information on a line-of-sight of a person taking the moving image, the image processing apparatus comprising:
a decoding unit configured to decode the coded data of moving image; and
a control unit configured to perform control such that the moving image decoded by said decoding unit is reproduced either by accessing a position, identified by the line-of-sight information, where the person taking the moving image starts to view the monitor or by joining together periods, identified by the line-of-sight information, during which the person taking the moving image is viewing the monitor.

9. An image processing apparatus that edits the coded data of moving image generated by an image processing apparatus according to claim 6, the coded data of moving image being related to the information on a line-of-sight of a person taking the moving image, the image processing apparatus comprising:
a decoding unit configured to decode the coded data of moving image; and
a control unit configured to perform control such that a part of the moving images corresponding to a period, identified by the line-of-sight information, during which the person taking the moving image is not viewing the monitor is deleted, or the entire moving images is deleted when the moving images decoded by said decoding unit contains the period, identified by the line-of-sight information, during which the person taking the moving image is not viewing the monitor.

10. An image processing apparatus that stores the coded data of moving image generated by an image processing apparatus according to claim 6, the coded data of moving image being related to the information on a line-of-sight of a person taking the moving image, the image processing apparatus comprising:
a ratio calculating unit configured to calculate a ratio of a viewing period over a non-viewing period for each of a plurality of coded data of moving images wherein the viewing period is a period, identified by the line-of-sight information, during which the person taking the moving image is viewing the monitor and the non-viewing period is a period, identified by the line-of-sight information, during which the person taking the moving image is not viewing the monitor; and
a sorting unit configured to sort out the plurality of coded data of moving images in the order starting from coded data whose calculated ratio is maximum or minimum.
